(19) United States
(12) Patent Application Publication
(10) Pub. No.: US 2024/0242851 A1
(43) Pub. Date: Jul. 18, 2024

(54) COMPONENTS FOR AN APPARATUS THAT PRODUCES A NEUTRON FLUX

(71) Applicant: OXFORD SIGMA LIMITED, Didcot , Oxfordshire (GB)

(72) Inventors: Thomas Davis, Didcot , Oxfordshire (GB); Matthew Lloyd, Didcot , Oxfordshire (GB)

(21) Appl. No.: 18/556,797

(22) PCT Filed: Apr. 22, 2022
(86) PCT No.: PCT/EP2022/060755

§ 371 Date: Oct. 23, 2023

(30) Foreign Application Priority Data
Apr. 22, 2021 (GB) 2105750.0

(51) Int. Cl. G21B 1/13; G21B 1/05; G21B 1/15

(52) U.S. Cl. CPC G21B 1/13; G21B 1/057; G21B 1/15

(57) ABSTRACT

New material compositions, designs and configurations for components for an apparatus that produces a neutron flux such as a nuclear fusion reactor, and methods of manufacturing said new components.

### FIELD OF DISCLOSURE

The present invention relates to material configurations and designs of components for use in an apparatus that produces a neutron flux e.g. a nuclear fusion reactor.

### BACKGROUND

As the demand for greener, cleaner energy grows, the energy sector shows an increasing interest in nuclear fusion energy technology. Nuclear fusion is a physical reaction where two nuclei fuse together, in response to them overcoming their Columbic repulsion. Nuclear fusion energy technology exploits this fundamental nuclear reaction through the fusion of two isotopes of hydrogen.

Hydrogen is the lightest known chemical element and is the most abundant chemical substance in the universe, constituting roughly 75% of all baryonic mass. Hydrogen has three naturally occurring isotopes: Protium (P), Deuterium (D), and Tritium (T). P is the most common isotope of hydrogen, and has one proton and no neutron. It accounts for more than 99.98% all the naturally occurring hydrogen in the Earth's oceans. D, also known as heavy hydrogen, contains one proton and one neutron and has a natural abundance in Earth's oceans of about one atom in 6420 of hydrogen, accounting for approximately 0.02% (0.03% by mass) of all the naturally occurring hydrogen in the oceans. T is a rare and radioactive isotope of hydrogen, and contains one proton and two neutrons. Naturally occurring tritium is extremely rare on Earth. The atmosphere has only trace amounts, formed by the interaction of its gases with cosmic rays. Nuclear fusion energy technology exploits the nuclear fusion of plasmas of D and T. Fusion reactions can also be performed using materials other than D and T, such as proton and boron-11 or D and He-3.

For magnetically confined fusion, D-T plasmas fuse under extreme temperatures (>50,000,000° C.), releasing energetic neutrons and helium nuclei. Around 80% of the 17.6 MeV of energy generated by fusion of D-T is acquired by the released neutron. This reaction is summarised in the following equation:

₁²D+₁³T→₂⁴He(3.52 MeV)+n⁰(14.06 MeV)

A number of magnetic confinement D-T plasma fusion devices, such as magnetic mirrors, the Z-Pinch, the Stellarator and the Tokamak, have been researched and developed over the years. To date, the most popular method of achieving D-T fusion is to use a Tokamak device, which uses a powerful magnetic field to confine hot D-T plasma in the shape of a torus.

The most advanced Tokamak designs are ‘D’ shaped Tokamaks (also known as a conventional Tokamak) such as the Joint European Torus and ITER, and spherical Tokamaks, which minimises the inner radius of the torus. Spherical Tokamaks have an aspect ratio of A<2.5, wherein the aspect ratio, A, is defined as the ratio of the major radius of the torus to the minor radius of the torus. The typical features of Tokamaks include a high plasma current, large plasma volume, auxiliary heating for plasma start-up and heating, and a strong toroidal magnetic field supplied by either conventional or superconducting magnets. For power generating fusion conditions, a Tokamak device needs to maintain a high confinement time, high plasma density, and high temperature to enable self-sustaining fusion.

FIG. 1 depicts, for illustration only, a cross-section of a toroidal Tokamak nuclear fusion reactor 100. The cross-section of the Tokamak nuclear fusion reactor reveals a hollow central portion 110 called the vacuum chamber, and a number of components such as a front wall 120 of breeder blanket tiles 130 that cover the inner surface of the Tokamak, and a divertor 140 situated at the bottom of the vacuum chamber.

Example components such as a front wall 120 and a divertor 140 are described below.

A breeder blanket tile 130 is a device for breeding Tritium for use in the nuclear fusion reactor and usually comprises a lithium-containing material that is exposed to neutrons released during the D-T fusion reaction. Another function of the breeder blanket is to extract the energy released by neutrons via neutronic heating to electricity production through the heat-steam turbine cycle.

The front wall 120 of a breeder blanket tile 130 is a wall that separates the fusion plasma of the nuclear fusion reactor from the internal components of the nuclear fusion breeder blanket tile 130. The front wall 120 is formed from a material that is permeable to neutrons, to facilitate a flux of neutrons passing from the fusion plasma through the nuclear fusion breeder blanket tile 130.

The divertor 140 (also known as a divertor component) is a device within the Tokamak that allows the removal of waste material from the plasma, such as helium, un-burnt tritium and deuterium, and structural material impurities, while the reactor is operating. This allows control over the build-up of fusion products in the fuel, and removes impurities that have entered the plasma.

For commercial power production, nuclear fusion reactors will need to operate in a steady-state, resulting in the components within the Tokamak experiencing extreme levels of heat flux (between 5-20 megawatts per m²) on account of the plasma, and neutron bombardment that occurs by neutrons produced by the fusion reaction. Accordingly, those must be formed from material(s) with high melting points and good high temperature mechanical properties.

The issue of high heat flux exposure and neutron irradiation damage are not limited to the diverter cassette and the breeder blanket, but is an issue associated with all components of the fusion reactor.

A unique phenomenon can occur when cooling the components with a neutron reflective and/or moderating material (wherein moderation is the act of slowing down neutron's energy by inelastic collisions with the material) that could increase the rate of radiation damage. For example, if components are cooled by water or hydrogenated material (such as methane) it will moderate the neutron energy (i.e. decrease) and reflect a portion of neutrons back into the structural material, leading to an increase in radiation damage.

Materials used for the components in regions of high neutron flux therefore must meet at least the following requirements: a high melting temperature (>1500° C.), a high thermal conductivity (>50 W/m/K), a high plasma sputtering threshold, a good high temperature operational window, and a good resistance to radiation damage. Furthermore the material should not produce high levels of nuclear waste. A few materials fit these criteria. Some examples include: Tungsten, Molybdenum, Carbon, Chromium, and Tantalum. However, as Carbon retains Tritium well, Tantalum is extremely expensive, Chromium recrystallizes at components operational temperatures, and Molybdenum has the potential to become significantly radioactive, Tungsten is the preferred base material for the components.

For the purposes of illustration only, FIG. 2 depicts in detail one such component of a nuclear reactor. FIG. 2 depicts an example divertor comprising a supporting structure in e.g. stainless steel (not shown) that surrounds an outlet pipe 210 and an inlet pipe 220. Atop of the supporting structure and/or the outlet pipe 210 and an inlet pipe 220 are three components: an inner vertical target 230, outer vertical targets 240, and a central part 250, referred to as a “dome”. The divertor component is the exhaust of the burnt, unburnt, and impurities to leave the plasma. The divertor may host a number of diagnostic components for plasma control and physics evaluation and optimization. Each of the inner vertical target 230 and the outer vertical target 240 is positioned at the intersection of magnetic field lines where plasma particle bombardment will be particularly intense. As the high-energy plasma particles strike the vertical targets 230, 240, their kinetic energy is transformed into heat, which can be removed by active cooling of the components. Divertors therefore provide a dual functionality of online removal of heat and waste material from the plasma.

The inner vertical target 230 and the outer vertical target 240 i.e. the components of the divertor, experience an estimated heat flux of ˜5-10 MW/m² (steady state) and 20˜MW/m² (slow transients) and >20 MW/m² during edge local mode disruption (for a commercial power reactor configuration). Accordingly, the inner vertical target 230 and the outer vertical target 230 must be formed from material(s) with high melting point, such as Tungsten.

Tungsten (also known as Wolfram, W) is a rare metal element which, in pure form has the highest melting point (3,422° C., 6,192° F.), lowest vapour pressure (at temperatures above 1,650° C., 3,000° F.), and has a high tensile strength. Naturally occurring W on Earth almost exclusively consists of four stable isotopes namely: W-182 (26.50%), W-183 (14.31%), W-184 (30.64%), and W-186 (28.43%), and one very long-lived radioisotope, W-180 (0.12%) [W-180 has a half-life of (1.8±0.2)×1018 years].

Metallic polycrystalline tungsten, in its un-irradiated form, appears to meet the structural and functional challenges that fusion energy poses on the components. However, it is well known in the field of nuclear materials that neutron irradiation causes severe damage to structural and functional materials, and is a source of safety concern.

Unfortunately, despite the beneficial high melting point and high thermal conductivity of W, when used in plasma-facing and other components it is subjected to high neutron flux (and fluences). This causes, for example, volume change (swelling), increases in yield stress/hardness (also known as embrittlement), reduced creep resistance, severe reduction in ductility, reduced thermal properties (such as thermal conductivity), and increased susceptibility to cracking from the environment.

Transmutation is the method of converting one element to another (and by extension one isotope to another) by nuclear processes. In particular for W, the neutron cross-sections of transmutation (also known as neutron absorption, a fundamental unit of probability of a particular nuclear reaction) are high enough with fusion neutrons (mainly due to tungsten resonance regions and fusion neutron fluence/flux) to produce significant amounts of transmutation that lead to changes in chemical behaviour and physical properties. This ultimately results in a limited shelf-life of W components in a fusion reactor.

Recent research in the field indicate that transmutation effects in W dominate the degradation of its mechanical and thermophysical properties, Furthermore, dislocations, dislocation loop and void formation caused by the bombardment of neutrons further affects the mechanical and thermophysical properties of W. Transmutation is a combination of nuclear processes which change the chemical makeup of a material that occurs under neutron irradiation. Transmutation effects in W include the formation of elements in W through a series of neutron absorption (n, gamma) or neutron loss reactions (n, 2n)/(n, 3n), and subsequent beta (B) decay. Often the isotopes produced during these neutron interaction events are unstable, and therefore undergo decay. In W this process leads primarily to the formation of isotopes of W, Rhenium (Re), Osmium (Os) and Tantalum (Ta), with Re being the primary transmutant.

An example neutron absorption process that gives rise to such transmutation effects is:

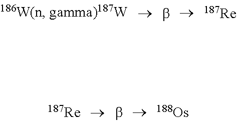

An example neutron loss process that gives rise to such transmutation effects is:

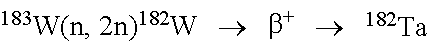

The skilled person will understand that the discussion above regarding the effects of high neutron flux on the front wall 120, and the divertor 140 is not limited to those specific components, but applies equally to all components in an apparatus that are proximate to a neutron flux. For example, the component in the apparatus may be a mechanical component such as a screw, nut, bolt, spring etc. Alternatively, the component may be a structural component such as a strut, frame, baffle, support structure, etc.

Hirai et. al discuss the use of W in ITER divertor designs, including a divertor design comprising W-based monoblocks in their paper entitled “Use of tungsten material for the ITER divertor” published in Nuclear Materials and Energy, Vol. 9, pp. 616-622 (2016).

Gilbert et. al. discuss methods of accurately quantifying the transmutation rate of W under neutron irradiation and the reflection and moderation of neutrons in water cooled monoblocks in their paper entitled “Spatial heterogeneity of tungsten transmutation in a fusion device” published in Nucl. Fusion, 57, 044002, (2017).

Gilbert and Sublet discuss transmutation reaction pathways in “Handbook of activation, transmutation, and radiation damage properties of the elements simulated using FISPACT-II & TENDL-2015; Magnetic Fusion Plants” published by Culham Centre for Fusion Energy (2016).

Lloyd et. al. discuss the effects of transmutation in Tungsten, and their impact on the degradation of its mechanical and thermophysical properties in their paper entitled “Decoration of voids with rhenium and osmium transmutation products in neutron irradiated single crystal tungsten” published by Scripta Materialia, Vol. 173, pp. 96-100, (2019).

A new material design and configuration for components for an apparatus that produces a neutron flux that significantly reduces the production of Re/Os via transmutation of W, decreases overall radioactivity inventory after use, decreases the rate of degradation of mechanical properties during operation, reduces the risk of structural failure, and will extend the shelf-life of such components (which increases the overall power plant availability). The new design comprises a tile structure and may be any component exposed to a high flux of neutrons, such as the first wall of a breeder blanket or a divertor, and is envisaged to improve the overall functioning of said apparatus e.g. a nuclear fusion reactor, and increases the longevity of the components).

Various embodiments and aspects of the present invention are described without limitation below, with reference to the accompanying figures.

### SUMMARY OF INVENTION

According to a first aspect of the present invention, there is provided a component for an apparatus that produces a neutron flux.

The component comprises: an isotopically enriched tungsten proximate to the neutron flux having a greater proportion of relatively light isotopes of tungsten than natural tungsten.

The component may further comprise a support section remote from the neutron flux, supporting the isotopically enriched tungsten.

The component may further comprise a conduit for the flow of a liquid, gas or molten salt. The conduit may itself be a source of reflected and moderated neutron flux, e.g. in the case where it is a highly moderating/reflecting cooling material, such as water or hydrogen/carbon containing gas, conduit.

The conduit may comprise: an outer layer comprising the isotopically enriched tungsten; and an inner layer comprising a material that is non-permeable to the liquid or gas or molten salt.

The invention extends the component's lifetime during operation by reducing the rate of Re/Os production by transmutation and mechanical damage to the component. The invention also reduces the production of radioactive waste, reduce the toxicity and radiotoxicity during disposal, and increases the safety operation during and after operation (in other words reduces the likelihood of failure).

Multiple configurations of components are envisaged in using isotopically enriched and natural tungsten (and other material systems) combination with multiple cooling options. These components will be components that experience high neutron fluxes, extreme heat fluxes, and plasma erosion, such as components that directly face a fusion plasma (plasma-facing components (PFCs) or first-wall tiles).

### BRIEF DESCRIPTION OF THE DRAWINGS

FIG. 1 depicts a cross-section of a toroidal Tokamak nuclear fusion reactor comprising PFCs.

FIG. 2 depicts an example diverter comprising PFCs.

FIG. 3a depicts a simple cross-section of a single PFC or other component of a nuclear fusion reactor.

FIG. 3b depicts an example of a plurality of PFCs back-to-back that form e.g. an inner vertical target and/or an outer vertical target of a diverter component.

FIG. 4 depicts a detailed cross-section of a PFC design.

FIG. 5a depicts a detailed cross-section in the x-y plane of another PFC design.

FIG. 5b depicts a detailed cross-section in the z-y plane of the PFC design depicted in FIG. 5a.

FIG. 6 an ion implantation method of manufacture for manufacturing the components of FIG. 3-5

FIG. 6 depicts a powder bed fusion method of manufacture for manufacturing the components of FIG. 3-5

FIG. 7 depicts a fused filament fabrication set up for manufacturing the components of FIGS. 3-5

FIG. 8 depicts a hot isostatic pressing set up for manufacturing the components of FIGS. 3-5.

FIG. 10 depicts a cold-spray set up for manufacturing the components of FIGS. 3-5.

### DETAILED DESCRIPTION

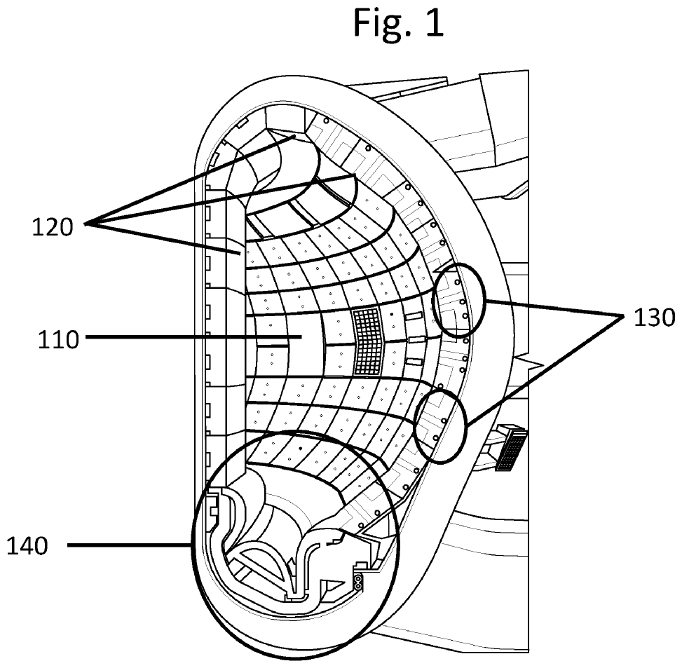

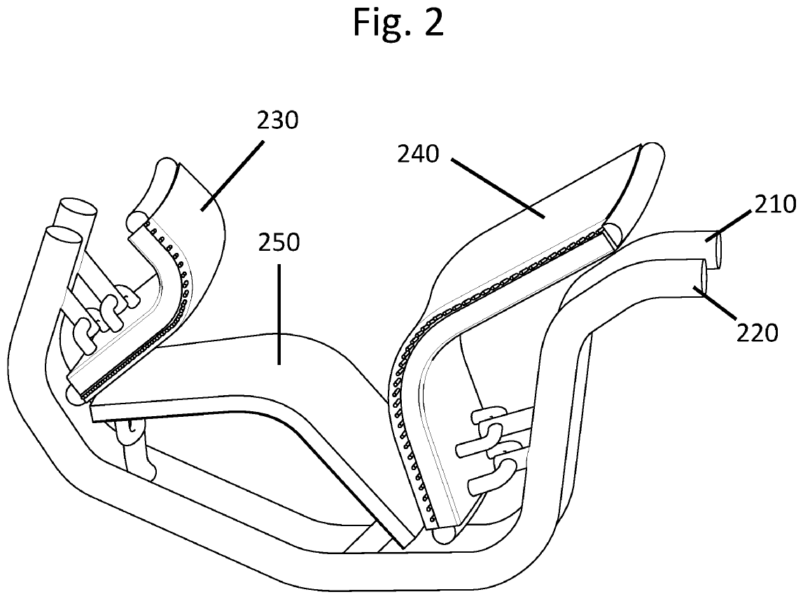

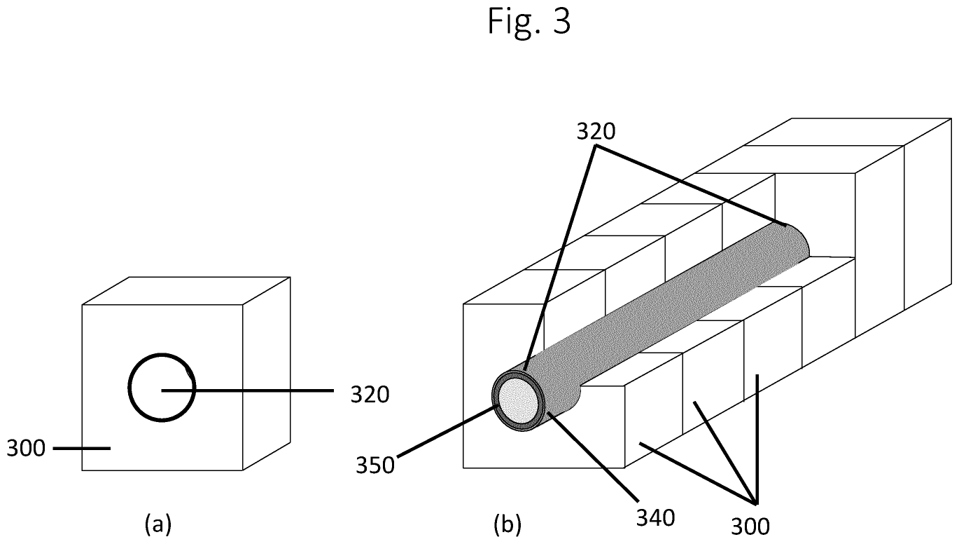

FIG. 3a depicts a cross-section of an example single component 300 that may form part of a plurality of PFCs. The component 300 may form, for example, part of the inner vertical target and/or an outer vertical target of the divertor, such as the example diverter depicted in FIG. 2, or as a first-wall tile of a breeder blanket, such as the example first-wall tiles depicted in FIG. 1 140. Alternatively, the component 300 and/or the plurality of such components may be located anywhere else in a nuclear fusion reactor, or may be used for, or attached to, a component of a nuclear fusion reactor where plasma is present, or neutron source is present (such as a fission reactor, neutron multiplication material, or a neutron scattering material)

The component 300 comprises isotopically enriched W proximate to a flux of neutrons (e.g. plasma-facing) having a greater proportion of relatively light isotopes of tungsten than natural W i.e. isotopically enriched W is lighter than natural W. In particular, isotopically enriched W may be depleted of W-186 with a remaining composition that includes W-180, W-182, W-183, and W 184.

The component 300 may be formed of a plurality of layers, wherein a level of isotopical enrichment of the layers of the component decreases as a function of depth of the component. One layer (e.g. one side) of the component may be formed of relatively lightly enriched tungsten or natural tungsten, while an opposite side of the component, more proximate to the neutron flux, may be formed of relatively heavily isotopically enriched tungsten. For example, one side of the component may comprise a layer of natural tungsten that may support an opposite side of the component that comprises heavily enriched tungsten. There may be varying levels of enrichment therebetween. I.e. the level of isotopic enrichment of the component may decrease as a function of depth from a layer of the component with a greatest level of enrichment.

Each component may comprise at least one conduit 320 through which a liquid, such as water, sodium, lead, or a lead-lithium mixture, or gases, such as helium, methane, carbon dioxide, or hydrogen (and their isotopes, such as deuterium), or molten salt, such as Li₂FBe₄, NaCl or KCl, may flow. The substance flowing through the conduit 320 will hereafter be referred to as a ‘fluid’.

FIG. 3b depicts a cross-section of the plurality of components 300 that are placed back-to-back to one another such that the at least one conduit 320 of each components 300 overlap to form one long conduit through which the fluid, may flow.

Alternatively, the at least one conduit 320 may comprise an opening in each component through which a pipe structure is inserted.

Alternatively, the at least one conduit 320 may comprise an opening in each component with a pipe structure integrally formed in the opening of each component. For example, the pipe structure may be formed within the components during the manufacturing of the components. Once the plurality of components are placed back-to-back, the pipe structure in the components will form one single pipe structure.

The at least one conduit 320 and/or the pipe structure inserted into the at least one conduit, or integrally formed with the opening of the component, may comprise an outer 340 layer and an inner layer 350.

The outer layer 340 may comprise isotopically enriched W, while the inner layer 350 may comprise a material that is non-permeable to the fluid in the conduit.

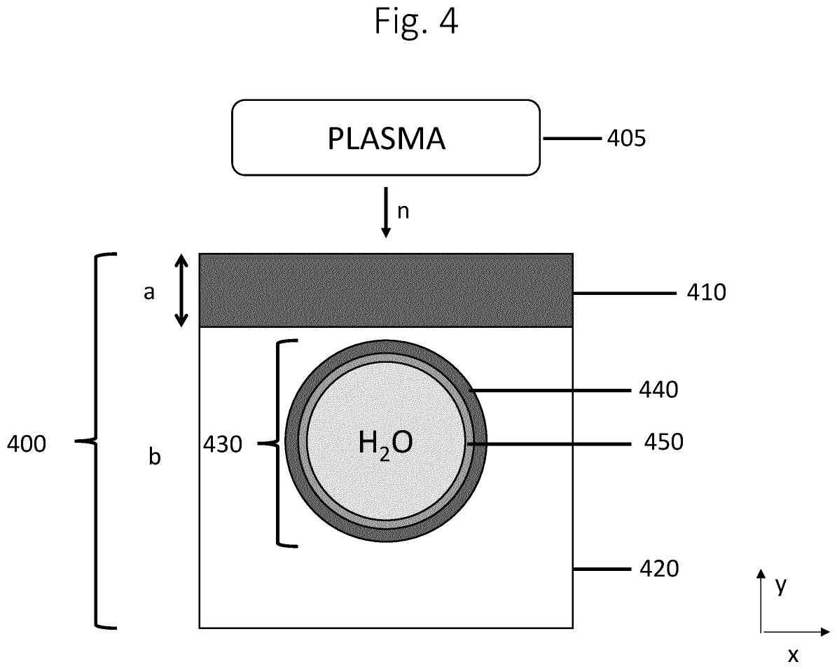

FIG. 4 depicts a detailed cross-section of a design of a component 400. The component 400 may form the inner vertical target and the outer vertical target of the diverter or a first-wall tile. Alternatively the component may be a plasma facing component in the fusion reactor. The component 400 comprises isotopically enriched W 410, proximate to the flux of neutrons, in the lighter isotopes than that of natural W. The component 400 further comprises a support section 420 remote from a flux of neutrons produced by a plasma fusion reactor, for supporting the component 400.

The support section 420 of the component 400 may comprise a solid block of W, wherein natural W has a natural isotopic abundance of W. In particular, the first section 410 of the component 400 comprises by weight, less than 1% W-180 and approximately, 26-28% W-182, 13-15% W-183, 30-32% W-184, and 27-29% W-186. A range has been provided as natural tungsten isotopic mark-up might change depending on location of the mine on Earth.

The component 400 may be formed of a plurality of layers, wherein a level of isotopic enrichment of the layers of the component decreases as a function of depth of the component. One side of the component may be formed of natural tungsten, while an opposite side of the component may be formed of heavily isotopically enriched tungsten. For example, a first section comprising a support section of the component may comprise natural tungsten, while a second section, atop of the first section, may comprise isotopically enriched layers of tungsten. In this way the level of enrichment in the layers of the second section may decrease as function of depth into the second section.

Alternatively, the support section 420 of the component 400 may comprise ferritic-based steel, austenitic-based steel, oxide dispersion strength steel, carbon-based materials, such as graphite, a refractory metal such as, natural or isotopically enriched Molybdenum (Mo), W, Tantalum (Ta), an alloy made of refractory metals such as Titanium-zirconium-molybdenum (TZM), a Ta-based alloy, or any other suitable material that reduces the overall cost of the production of the components such as Beryllium (Be)

The isotopically enriched W 410 of the component 400 is depleted of W-186 with a remaining composition that includes W-180, W-182, W-183, and W-184. For example the isotopically enriched W may be enriched with W-180, W-181, W-182, W-184 or W-183.

Preferably, isotopically enriched W 410 of the component 400 comprises W-182, W-183, or a combination thereof. The isotopically enriched W 410 of component 400 should be defunded of W-186.

The isotopically enriched W of the component 400 preferably comprises, by weight: greater than the natural percentage of W-182 (preferably greater than 28% W-182), greater than the natural percentage of W-183 (preferably greater than 15% W-183) or a combination thereof. Where enriched, W-182 is enriched to at least 42% (preferably at least 60%) and/or the W-183 is enriched to at least 23% (preferably at least 30%).

The isotopically enriched W of the component 400 may comprise, by weight: at least more than the natural percentage of W-182.

The isotopically enriched W 410 of the component 400 has a thickness (a) of at least 100 nm. Preferably the isotopically enriched W 410 has a thickness (a) of between 100 nm to 20 cm. More preferably, the isotopically enriched W 420 has a thickness (a) of 1 μm to 10 cm.

When assembling in a first-wall or divertor region, the plasma-facing isotopically enriched W 410 of the PFC 400 may be tilted (˜0.5 degrees) to protect the surface from misalignments (in μm to mm). This is to reduce local hotspots from the plasma bombardment on the tile structure. All designs disclosed will include such a feature, if necessary.

Advantageously, the displacement of W-186 suppresses the production Re and Os isotopes by transmutation. Re and Os elements severely degrade the chemical and physical properties of W metal during operation. By reducing the quantity of W-186 from the bulk material, transmutation routes to Re and Os are suppressed.

Advantageously, the removal of Re and Os transmutation products will extend the lifetime of any component during operation, as the mechanical and thermophysical properties are coupled to the level of transmutation, and will therefore degrade at a slower rate compared to natural W. This widens the operational safety window, decreases the failure rate, and increases the performance of the components. Moreover, this could increase the overall plant availability, as less component replacements will be required.

A further advantage is that the removal of W-186 will reduce the rate at which thermophysical properties degrade during operation, such properties include thermal diffusivity and thermal conductivity. Those properties are essential to the operation of e.g. a first-wall component, as one of their primary roles is to conduct heat flux away from the component into a coolant.

A further advantage is that the removal of W-186 reduces the long-term radioactivity level produced from neutron activation processes per specific mass. This feature will reduce the burden of radioactive waste that a fusion reactor will produce.

A further advantage is that the removal of W-186 and W-187 reduces the heat generated by radioactive decay (W/kg), as highly radioactive isotopes, such as Re-186, Re-186, W-187, and Re-184 will no longer be present, or formed via transmutation, in the component. With those highly radioactive isotopes removed the specific heat output generated by radioactive decay is reduced (W/kg), the specific radioactivity is also reduced (Bq/kg) and the gamma dose rate is reduced (W-187 and Re-186 dominate the gamma dose rate).

A further advantage is that the removal of (radioactive) Os reduces/removes the radiotoxicity, toxicity, and hazards associated with this element and its associated compounds. For example, under a loss of vacuum accident, ingress oxygen reacts with radioactive Os (generated by the transmutation of W and Re) to form Osmium tetroxide, which is volatile.

A further advantage is that isotopically enriched W will become more transparent to neutrons compared to natural W (i.e. a greater neutron population will pass through the material), thus increasing the tritium breeding ratio within breeder blankets when this invention is used as first-wall tiles in these devices.

Alternatively, the isotopically enriched W 410 of the component 400 proximate to the plasma 405 comprises a solid block of enriched W with a surface layer of yttrium-containing W for oxidation resistance under a loss-of-vacuum accident where oxygen ingresses. In particular, the oxidation enriched W may comprise an alloy comprising Yttrium (Y) and Chromium (Cr) such as, W-(10-14 Cr)-(0.25-1 Y) [wt %].

Advantageously, the use of Y and Cr preferentially form oxides compared to W during a loss-of-vacuum accident where oxygen will ingress. The suppression of the formation of tungsten tri-oxide is advantageous, as the compound is toxic to humans, will be radioactive in a fusion environment, and oxidise at a few kg/hr rate.

The component may also include at least one conduit 430 for the flow of fluid to cool the tile during operation. The conduit 430 depicted in FIG. 4 is circular. However, that shape is for illustration only. Other shapes for the conduit 430 are envisaged such as e.g. a square shaped conduit, or a rectangular shaped conduit. A swirl tube tape could be used in the cooling tube to increase the heat transfer coefficient of the coolants. Furthermore, the conduit 430 depicted in FIG. 4 is in the centre of the support section 420 of the component. However, the position of the conduit 430 in the support section 420 is for illustration only. The conduit 420 may be in any position of the support section 420 of the component 400. Alternatively, the conduit 430 may be located in the isotopically enriched W 410 of the component 400. FIG. 4 depicts only one conduit; however, a number of conduits may be included for optimal cooling.

The conduit 430 comprises an outer layer 440 and an inner layer 450.

The outer layer 440 comprises isotopically enriched W. The isotopically enriched W of the outer layer may be the same as the plasma-facing isotopically enriched W 410 of the component 400.

The outer layer 440 of the conduit 430 has a thickness of between 500 μm to 5 cm.

The inner layer 450 comprises a material that is non-permeable to the fluid in the conduit. For example, if the fluid in the conduit 430 is water, then the inner layer 450 may comprise a metal alloy such as a copper-based alloy (such as copper-chromium-Zirconium, CuCrZr), zirconium-based alloys, ferritic-based steels, austenitic-based steels, oxide dispersion strengthened steels, nickel-based alloys or a combination thereof.

Alternatively, the liquid in the conduit 430 may be liquid sodium, lead, lead-lithium alloy, or a gas (helium, methane, carbon dioxide, or hydrogen (including isotopes of each, if any), or a molten salt (Li₂BeF₄, NaCl, KCl, etc.).

If a molten salt coolant is used, it will be preferable to use a refractory material to face the coolant, such as Mo, TZM alloy, natural W, isotopically enriched W, or nickel-based alloys, or steels.

It will be understood by the skilled person that a wide variety of fluids may be included in the conduit 430 and that the inner layer 450 will comprise of a material selected from the known materials that are non-permeable to said fluid. The material may be a single known material, or may be a combination of known materials.

The inner layer 450 may also have an oxide coating, such as aluminium oxide (III), to reduce hydrogen gas permeation (such as tritium production in molten salts or lead-lithium liquid alloy) or corrosion.

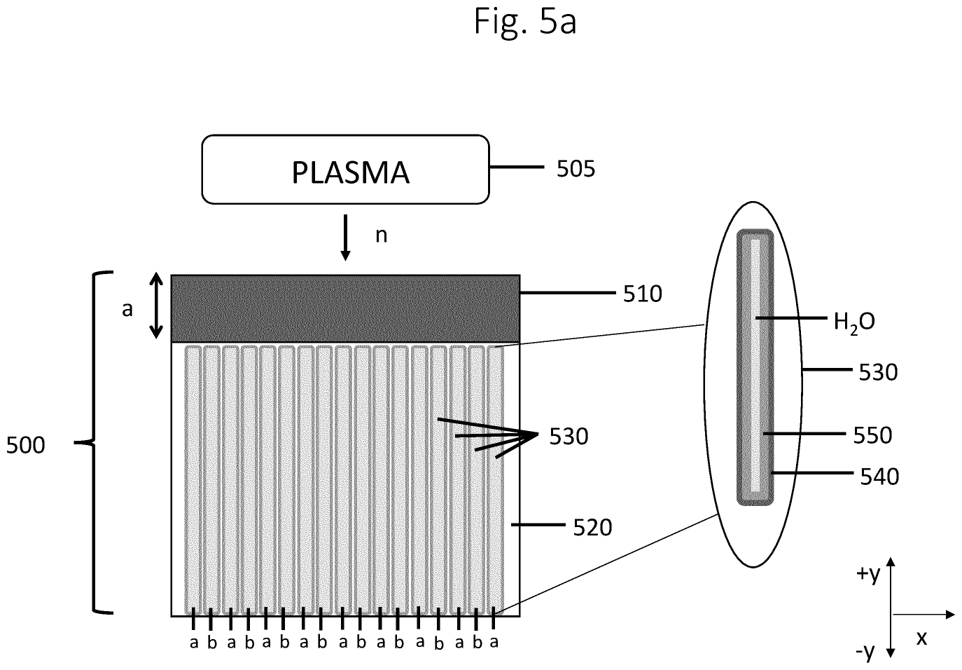

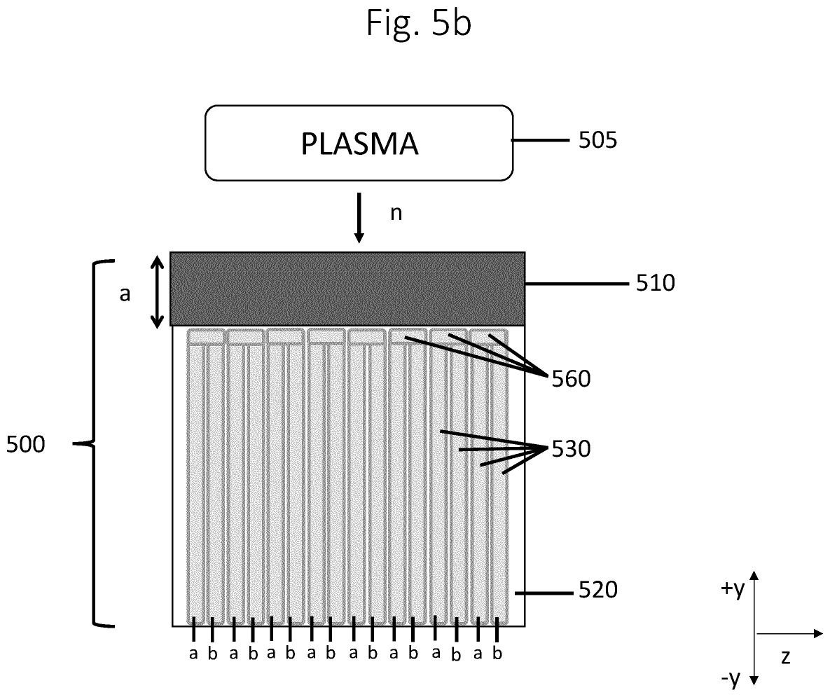

FIG. 5a depicts a detailed cross-section of another PFC 500 in the x-y plane. The PFC 500 comprises plasma-facing isotopically enriched W 510, and a support section 520 remote from a flux of neutrons produced by a plasma fusion reactor. The dimensions of the PFC 500 may be the same as the dimensions of the component 400.

The support section 520 of the PFC 500 may be the same as the support section 420 of the component 400. For example, the support section 520 may comprise the same material as the support section 420.

The plasma-facing isotopically enriched W 510 of the PFC 500 may be the same as the plasma-facing isotopically enriched W 410 of the component 400. For example, the plasma-facing isotopically enriched W 510 may comprise the same composition as the isotopically enriched W 410. The plasma-facing isotopically enriched W 510 may also have the same thicknesses as the isotopically enriched 410. Furthermore, plasma-facing isotopically enriched W 510 has the same advantages as the isotopically enriched 410.

The PFC 500 may also include at least one conduit 530 for the flow of a liquid, gas, or molten salt (“fluid”) to cool the tile during operation. The conduits 530 depicted in FIG. 5 are located in the support section 510 of the PFC, and run in the y direction of the support section 510. However, the conduits 530 may run in any direction in the support section 510. Also the position of the conduits 530 in the support section 510 is for illustration only. Alternatively the conduit 520 may be located in the plasma-facing isotopically enriched W 510, or may be in the plasma-facing isotopically enriched W 510 and the support section 510.

Each conduit 530 in the support section 520, as depicted in FIG. 5, is narrow and long and extends along the thickness of the support section 510 and forms a “finger-like” conduit. The conduits 530 are spaced apart from one another.

Each of the conduits 530 has the same configuration as the conduit 430 in the PFC 400, with an outer layer 540 and an inner layer 550. The outer layer 540 and the inner layer 550 may comprise the same materials as the outer layer 440 and the inner layer 450. The outer layer 540 and the inner layer 550 may also have the same thicknesses as the outer layer 440 and the inner layer 450.

Conduits 530 may be connected to one another to allow flow of the fluid between the conduits. For example, the conduits may be connected together in pairs to form a series of ‘U’-shaped conduits. Alternatively, the conduits may be connected to form one long a ‘snake’-like conduits. Alternatively, the conduits may be connected to conduits in a different plane to the x-y plane such as to form a labyrinth, or maze-like three-dimensional (3D) array of conduits that are connected together. The skilled person will understand that there are many possible configurations of the conduits in the component to allow the flow of the fluid. The configuration of conduits will be based on optimisation of cooling.

FIG. 5b depicts an example of one such configuration of the conduits in the PFC 500 in the x-z plane. In the example of FIG. 5b pairs of conduits 530 are connected into pairs of “U” shaped conduits through which the fluid can flow. The pairs conduits 530 may also be connected to further conduits in the third dimension to form a labyrinth, or maze-like three-dimensional (3D) array of conduits. However the skilled person will understand that the configuration of the conduits in FIG. 5b and the manner in which they are connected is an example configuration, and that other possible configurations may be used.

The skilled person will understand that components 400 and 500 are examples of components in an apparatus that produces a neutron flux and are not exhaustive. Any component of an apparatus the produces a neutron flux may need to be designed and configured in the manner described above using isotopically enriched W. For example, the component could be a mechanical component such as a screw, nut, bolt, spring etc. Alternatively, the component could be a structural component such as a strut, frame, baffle, support structure, etc.

A description of a number of different methods of manufacture/construction of the components described above now follows.

### Ion Implantation

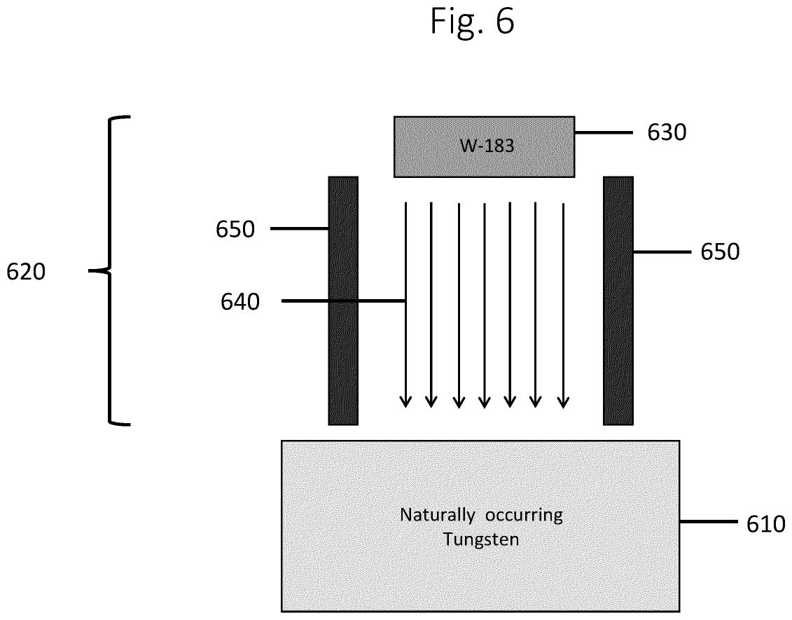

FIG. 6 depicts an ion implantation set up for the implantation of ions into a surface of materials for manufacturing the component of FIGS. 3-5. Ion implantation methods can be used to impregnate a surface of a material with another substance.

For example, FIG. 6 depicts a block 610 of W that comprises natural W on one side of e.g. a pelletron 620 (a pelletron is a type of electrostatic particle accelerator). There is also provided a source 630 of enriched W that is enriched with one of the many isotopes of W e.g. W-183. The source 630 of enriched W may be e.g. a natural W metal powder as a sputtering ion source, or an enriched W powder (the latter increases the sputtering yield of the wanted isotope). Other formats of the source 630 are also envisaged.

The source 630 of enriched W is provided at a side of e.g. a pelletron opposite to the block 610 of W. During operation of the pelletron a beam 640 of enriched W from the source 630 of enriched W is directed toward the surface of the block 610 of W via a series of accelerator electrostatic magnets 650. As that beam of enriched W bombards the surface of the block 610 of W they implant themselves into the surface of the block 610 of W to enrich the block 610 of W with e.g. W-183.

Alternatively, the source 620 may be a source of natural W. In this instance a switching magnet prior to the ion acceleration section 650 is provided in the pelletron to separate out different isotopes that form the natural W.

Once separated, the isotopes of W that one wishes to enrich the block 610 of W with e.g. W-183 are directed toward the block 610 in a beam 640 via the series of accelerator magnets 650, while the other isotopes of W are directed to waste material collector via the same series of accelerator magnets 650. This can be achieved because different isotopes of a chemical have different chemical masses and so their trajectory in a magnetic field varies.

The skilled person will understand that other types of particle accelerator set ups other than those depicted may be used to facilitate the same ion implantation process described above. In addition, the skilled person will understand that the flux, temperature, and a post-annealing process will need to be controlled to optimise the layer adhesion and material properties of the component.

The ion implantation method of manufacture advantageously allows for shallow layers of pure isotopic enrichment, which is where the highest neutron flux is present along with plasma bombardment from the fusion plasma. The enriched section would also reduce the chance of Os transmutation product to react with oxygen during a loss-of-vacuum accident where oxygen ingresses (Os forms OsO₄, which is extremely toxic to humans, and is also radioactive in a fusion environment). The surface ion implantation method significantly reduces the risk of Os release from natural W in an accident scenario.

### Powder Bed Fusion (PBF)

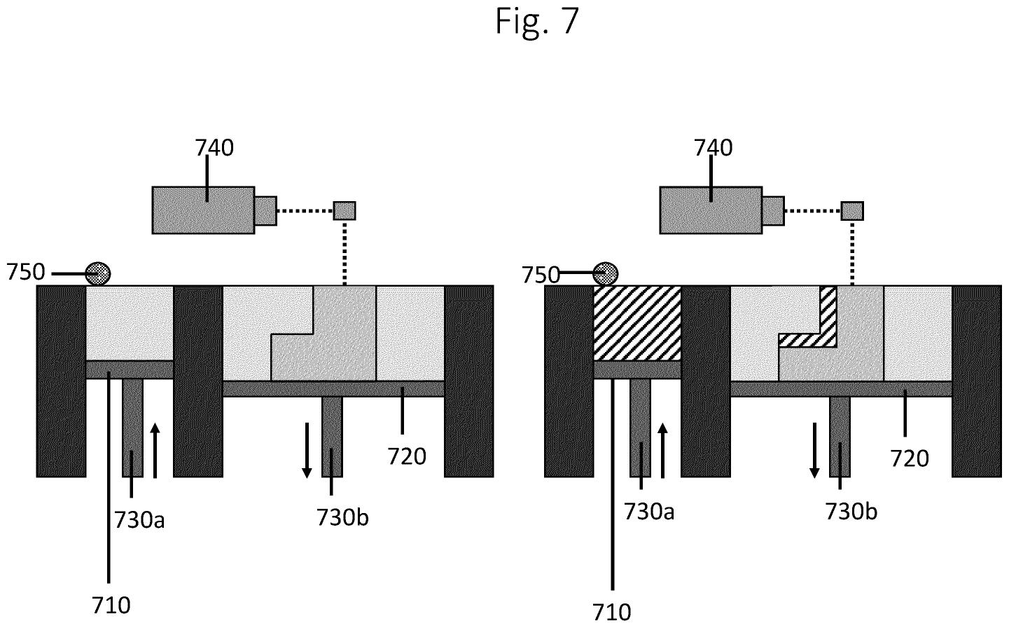

FIG. 7 depicts a PBF set up for manufacturing the component of FIGS. 3-5. Powder bed fusion is an additive manufacturing (AM) process where an energy source, such as a laser or electron beam, is used to fuse particulate materials such as metals, ceramic or polymers together to form a three-dimensional (3D) object. Common techniques include selective laser sintering, selective laser melting, and electron beam melting. PBF processes involve the spreading of a powder material over previously formed layers, which are then fused with the previous layers through the use of the energy source. There are different mechanisms to spread the power material over the previously formed layer including a roller or a blade.

In PBF there is a powder platform 710 which holds and stores the current powder to be used to form the 3D object, and a build platform 720 where the 3D object is formed. Both the powder platform 710 and the build platform 720 operate on e.g. a piston (730a; 730b) that allows each of the respective platforms to be raised or lowered as required.

### Fused Filament Fabrication (FFF)

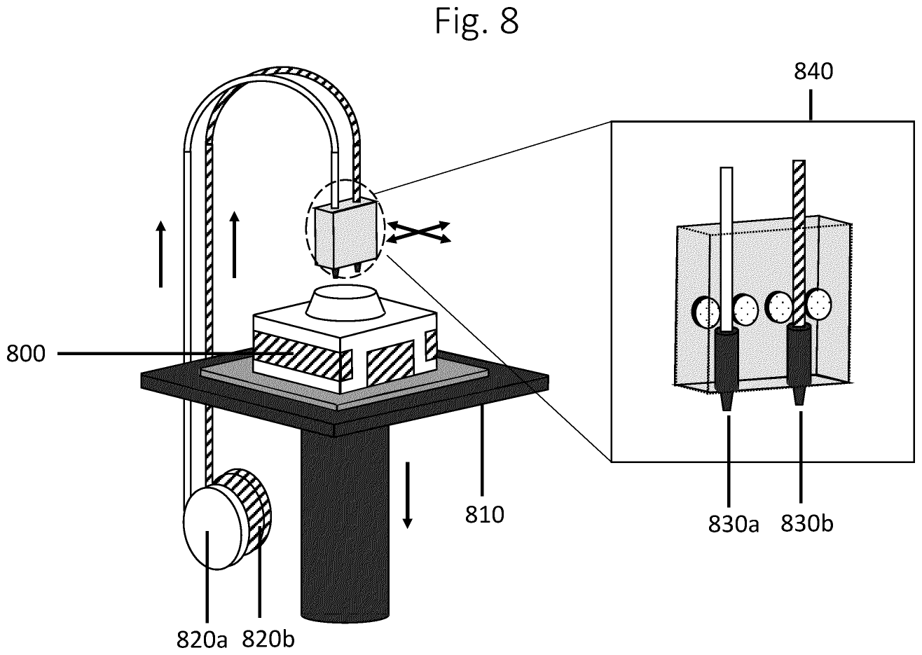

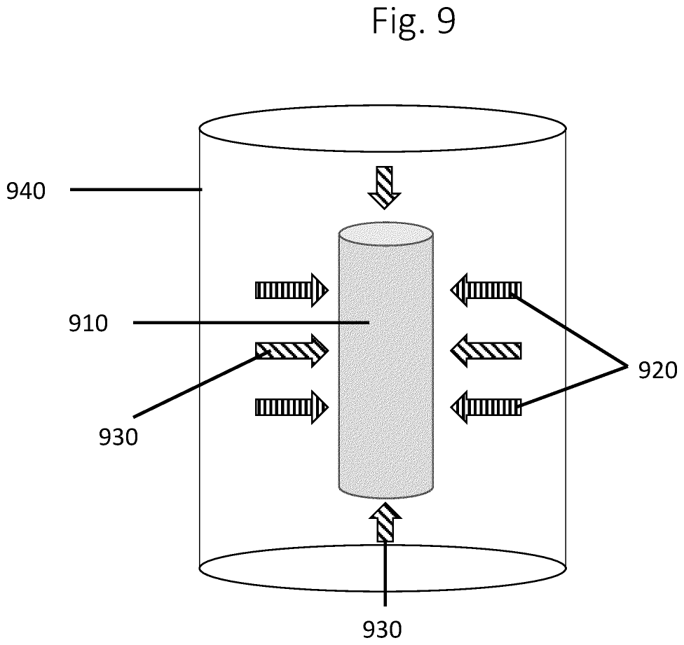

FIG. 8 depicts a FFF set up for manufacturing the component of FIGS. 3-5. Fused filament fabrication is an additive manufacturing (AM) process that uses a continuous filament of a thermoplastic material. The filament is fed from a large spool through a moving, heated printer extruder head, and is deposited on the growing work (the component), which is formed on a platform 810.

FIG. 8 depicts a FFF set up comprising two spools 820a, 820b, each connected to a respective nozzle 830a, 830b of the heated printer extruder head 840. One of the spools 820a comprises of a spool of natural W, which is connected to a first nozzle 830a of the heated printer extruder head 840. The other spool 820b comprises a spool of isotopically enriched W, which is connected to a second nozzle 830b of the heated printer extruder head 830.

As the heated printer extruder head with the nozzles is moved over the platform in a prescribed geometry, it deposits a thin bead of extruded plastic, called a “road” from either the first nozzle or the second nozzle depending on the section of the component that is being manufactured at that time. Once deposited, the “road” solidifies quickly upon contact with substrate “roads” deposited earlier.

Once a full layer has been deposited the platform is lowered, and the next layer is deposited.

During the manufacture of the component using FFF, the component may be constructed layer by layer in increasing levels of isotopic W enrichment. In this way a level of isotopic enrichment of the layers of the component decreases as a function of depth from the most istoptically enriched layer of the component.

### Hot Isostatic Pressing (HIP)

FIG. 9 depicts a HIP set up for manufacturing the component of FIGS. 3-5. HIP is a manufacturing process, used to reduce the porosity of metals and increase the density of many ceramic materials. This improves the material's mechanical properties and workability.

During HIP manufacturing a component 910 is subjected to both elevated temperature 920 and isostatic gas pressure 930 in a high pressure containment vessel 940. The pressurising gas used is an inert gas so that the material that forms the component 910 does not chemically react with the pressurising gas. The most widely pressurising gas used is argon, however the use of other chemically inert gases are possible (e.g. He).

To manufacture the component of FIGS. 3-5, using a HIP a component 910 comprising a green compact is used. The green compact is then placed into the high-pressure containment vessel 940 and is subjected to both elevated temperature 920 and isostatic gas pressure 930 to produce the finished component.

A green compact is a solid component created through powder pressing techniques, wherein powders are pressed and compacted into a geometric form/shape/configuration. The strength of the green compact is dependent on compactability, and typically can be broken apart by hand but is also strong enough to be handled, gently.

For the HIP manufacturing of the component of FIGS. 3-5 the green compact comprises a distribution of powders of natural W and enriched W in accordance with the design and configuration of the component.

### Cold Spraying

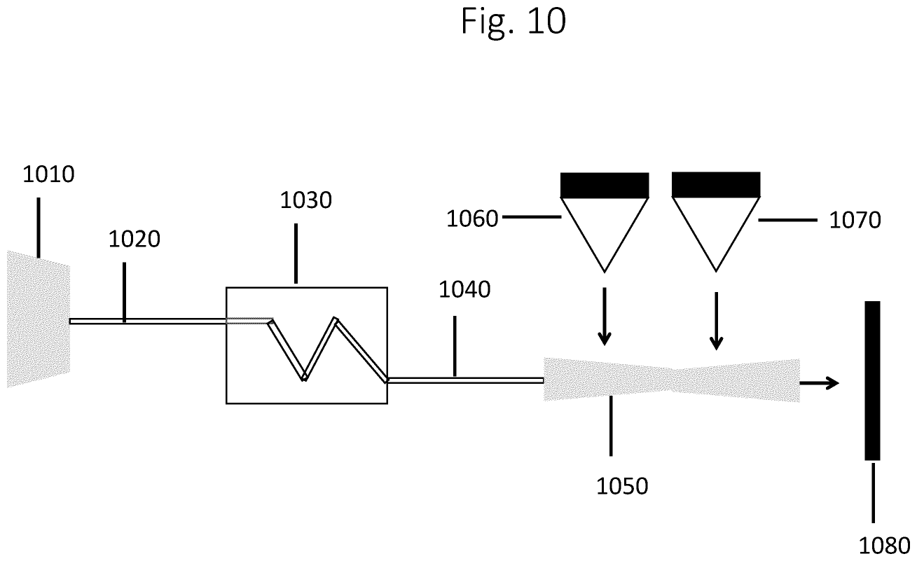

FIG. 10 depicts a cold spray set up for manufacturing the component of FIGS. 3-5. The cold spraying set up comprises a compressor 1010 through which a gas is passed to be compressed. The gas used is an inert gas, such as argon or helium, so that the gas does not react with any other substance that the gas comes into contact with during the manufacture process.

Once compressed, the gas stream 1020, which is cold, is passed through a heat exchanger 1030 to heat the gas, thereby producing a heated gas stream 940. The heated gas stream 1040 subsequently passes through a nozzle 1050 which is connected to two reservoirs of powders 1060, 1070. The first reservoir of powder 1060 contains powder of natural Tungsten and the second reservoir of powder 1070 contains powder of enriched Tungsten. Alternatively, the first reservoir of powder 1060 contains powder of enriched Tungsten and the second reservoir of powder 1070 contains powder of natural Tungsten.

During manufacturing, the first reservoir and second reservoir of powders 1060, 1070 are operated to feed either natural W or enriched W into the nozzle and thus into the pathway of the heated gas stream. The heated gas stream acts to spray the powder that enters the nozzle onto a substrate 1080. The substrate's materials could be based on ferritic steels, austenitic steels, oxide dispersion strengthen steels, Nickel-based alloys, Molybdenum-based alloys, or Copper based alloys. During operation, whether the natural W or enriched W is fed into the nozzle can be controlled by a switching mechanism (not shown). As the powders are deposited on the substrate 1080 by the hot air stream passing through the nozzle the component is built up.

The cold spray set up of FIG. 10 is an example set up only. The skilled person will appreciated that the set up of FIG. 10 is a low pressure cold spray set up. However alternatively, the cold spray set up may be configured to be a high pressure cold spray set up.

In addition, the skilled person will appreciate that post-annealing treatment would be required for the cold-sprayed W component to relief internal stresses induced during the manufacturing process.

It is to be understood that the claims are not limited to the precise configuration and components illustrated above. Various modifications, changes and variations may be made in the arrangement, operation and details of the components such as first-wall and divertor components, and its method of manufacture described above without departing from the scope of the invention as defined in the appended claims.

1. A component for an apparatus that produces a neutron flux, the component comprising:
a support section of natural tungsten; and
at least one conduit formed in the support section for the flow of a liquid, gas or molten salt; wherein the at least one conduit comprises:
an outer layer comprising isotopically enriched tungsten having a greater proportion of lighter isotopes of tungsten than natural tungsten; and
an inner layer comprising a material that is non-permeable to the liquid or gas or molten salts.

2. The component of claim 1, wherein a level of isotopic enrichment of the face decreases as a function of depth into the component.

3. The component of claim 1 wherein the support section further comprises one of:
ferritic-based steels;
austenitic-based steels;
oxide dispersion strengthened steels;
graphite, or other carbon-based materials;
natural or isotopically enriched molybdenum;
titanium-zirconium-molybdenum, TZM;
tantalum-based alloys;
copper-chromium-zirconium, CuCrZr, or other copper-based alloys; or
beryllium.

4. (canceled)

5. (canceled)

6. The component of claim 3, wherein the inner layer comprises one of:
a copper-chromium-zirconium, CuCrZr, or other copper-based alloys;
ferritic-based steels;
austenitic-based steels;
zirconium-based alloys;
oxide dispersion strength steels;
isotopically enriched tungsten;
natural or isotopically enriched molybdenum;
titanium-zirconium-molybdenum, TZM; or
nickel-based alloys.

7. The component of claim 6, wherein the inner layer comprises a ceramic coating.

8. The component of claim 7, wherein the ceramic coating comprises:
aluminium oxide; or
chromium oxide.

9. The component of claim 1, wherein natural tungsten comprises by weight,
26-28% tungsten-182,
13-15% tungsten-183,
30-32% tungsten-184, and
27-29% tungsten-186.

10. The component of claim 1, wherein the isotopically enriched tungsten is enriched with tungsten of atomic weight of 184 or less.

11. The component of claim 10, wherein the isotopically enriched tungsten is further enriched with tungsten-182, tungsten-183, or a combination thereof.

12. The component of claim 1, wherein the isotopically enriched tungsten comprises by weight:
greater than the natural percentage of tungsten-182; and
greater than the natural percentage of tungsten-183.

13. The component of claim 1, wherein the isotopically enriched tungsten comprises by weight:
greater than the natural percentage of tungsten-182.

14. The component of claim 1, wherein the first-support section and/or the conduit outer layer has a thickness of at least 100 nm.

15. The component of claim 1, wherein the first-support section has a thickness of between 100 nm and 20 cm.

16. The component of claim 15, wherein the support section has a thickness of between 1 μm and 10 cm.

17. The component of claim 15, wherein the outer layer has a thickness of between 500 μm and 5 cm.

18. A divertor for a nuclear fusion reactor comprising a support section of natural tungsten and at least one conduit for the flow of a liquid, gas or molten salt;
the least one conduit comprising:
an outer layer comprising isotopically enriched tungsten having a greater proportion of lighter isotopes of tungsten than natural tungsten; and
an inner layer comprising a material that is non-permeable to the liquid or gas or molten salts.

19. (canceled)

20. (canceled)

21. The component of claim 1, further comprising a face that, in use, faces the source of neutron flux and extends across the support section, the face comprising isotopically enriched tungsten having a greater proportion of lighter isotopes of tungsten than natural tungsten.

22. The component of claim 1, wherein the component is a breeder blanket tile.

23. The component of claim 1, wherein the component is a first-wall component for a nuclear fusion reactor.

24. A divertor for a nuclear fusion reactor comprising a support section of natural tungsten; and
a face that, in use, faces into the reactor and extends across the support section, the face comprising isotopically enriched tungsten having a greater proportion of lighter isotopes of tungsten that natural tungsten.
